(19) United States
(12) Patent Application Publication
(10) Pub. No.: US 2025/0005620 A1
(43) Pub. Date: Jan. 2, 2025

(54) INDIVIDUAL-BASED MARKETING APPROACH IN THE METAVERSE

(71) Applicant: International Business Machines Corporation, Armonk, NY (US)

(72) Inventors: Jignesh Karia, Thane (IN); Mukundan Sundararajan, Bangalore (IN); SHILPA SHETTY, Sydney (AU); Pankaj Satyanarayan Dayama, Bangalore (IN); NEHA SHAH, Kolkata (IN)

(21) Appl. No.: 18/341,890

(22) Filed: Jun. 27, 2023

(51) Int. Cl. G06Q 30/0251; G06Q 20/38; G06Q 30/0272

(52) U.S. Cl. CPC G06Q 30/0257; G06Q 20/383; G06Q 30/0272

(57) ABSTRACT

A method includes enabling a plurality of users to interact with a virtual world, each of the users represented as one or more avatars in the virtual world, obtaining preferences and consent of each of the users, displaying promotional messages to a user of the plurality of users in the virtual world based on the user's preferences and consent, and after displaying the promotional messages to the user, filtering the user's preferences and consent from the virtual world to remove transaction footprints.

### BACKGROUND

The present invention relates generally to marketing approaches in the metaverse, and more specifically, to individual-based marketing approaches in the metaverse.

The metaverse is an emerging 3D-enabled digital space that uses virtual reality, augmented reality, and other advanced internet and semiconductor technology to allow people to have lifelike personal and business experiences online. The metaverse is a virtual immersive environment or virtual world. The metaverse spans the virtual and the physical worlds. In the metaverse, an individual can select a persona, also referred to as an avatar, who represents the individual. This avatar provides a transition of the individual from the real world to the metaverse. In the metaverse, for an event, multiple brands can participate with their own specific products, which are available for usage to the avatars through sales or as features. The brands which participate in a metaverse event will try to maximize their reach to the avatars in the metaverse. Also, individual avatars would like to be aware of the brands which are of their particular preference. Current marketing approaches in the metaverse are crowd-based, where the particular preferences of the individual avatars are not considered.

### SUMMARY

In accordance with an embodiment, a method for is provided. The method includes enabling a plurality of users to interact with a virtual world, each of the users represented as one or more avatars in the virtual world, obtaining preferences and consent of each of the users, displaying promotional messages to a user of the plurality of users in the virtual world based on the user's preferences and consent, and after displaying the promotional messages to the user, filtering the user's preferences and consent from the virtual world to remove transaction footprints

In accordance with another embodiment, a computer program product for implementing individual-based marketing approaches in a virtual world is provided, the computer program product comprising a computer readable storage medium having program instructions embodied therewith. The program instructions are executable by a computer to cause the computer to enable a plurality of users to interact with a virtual world, each of the users represented as one or more avatars in the virtual world, obtain preferences and consent of each of the users, display promotional messages to a user of the plurality of users in the virtual world based on the user's preferences and consent, and after displaying the promotional messages to the user, filter the user's preferences and consent from the virtual world to remove transaction footprints.

In accordance with yet another embodiment, a system for implementing individual-based marketing approaches in a virtual world is provided. The system includes a memory and one or more processors in communication with the memory configured to enable a plurality of users to interact with a virtual world, each of the users represented as one or more avatars in the virtual world, obtain preferences and consent of each of the users, display promotional messages to a user of the plurality of users in the virtual world based on the user's preferences and consent, and after displaying the promotional messages to the user, filter the user's preferences and consent from the virtual world to remove transaction footprints.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of individuals in the real world participating in the metaverse as avatars where an activity is triggered by the individual, in accordance with an embodiment of the present invention;

FIG. 2 is a block/flow diagram of individuals in the real world participating in the metaverse as avatars where a brand displays an advertisement based on an individual's preferences, in accordance with an embodiment of the present invention;

FIG. 3 is a block/flow diagram of individuals in the real world participating in the metaverse as avatars where a brand displays an advertisement based on a union or combination of the avatar features and the real world preferences of the individual, in accordance with an embodiment of the present invention;

FIG. 4 is a block/flow diagram of a method for linking individuals in the real world with brands in the metaverse, in accordance with an embodiment of the present invention;

FIG. 5 is a block/flow diagram for implementing a blockchain for linking individuals in the real world with brands in the metaverse, in accordance with an embodiment of the present invention;

FIG. 6 is a block diagram of an exemplary computer system for applying the individual avatar marketing network, in accordance with an embodiment of the present invention; and

FIG. 7 is a block/flow diagram of an exemplary method for applying the individual avatar marketing network, in accordance with an embodiment of the present invention.

Throughout the drawings, same or similar reference numerals represent the same or similar elements.

### DETAILED DESCRIPTION

Embodiments in accordance with the present invention provide methods and systems for providing individual-based marketing approaches in the metaverse. An individual can have multiple avatars. While attending an event in the metaverse, the individual can use any one of his/her avatars which are available for a particular platform. Each of these avatars may have its own features, different from the other avatars of the individual.

In the real world, individuals have preferences or choices, and if such preferences can be passed from the real world to the metaverse, such preferences or choices can provide an avatar in the virtual world with its preferred options. In other words, the avatar can be associated with preferences. For example, if there is a musical event taking place on a metaverse platform, multiple brands are permitted to participate in the musical event as vendors or sponsors. The individual is also participating in the musical event. Suddenly, the individual may feel hungry and trigger the same in the metaverse. Based on this trigger event by the individual, the vendors or sponsors, based on the preferences attached or associated with the avatar of the individual, display a promotional message related to food items as per the user preference/consent for a particular brand.

Moreover, in the metaverse, there are certain sections or places or locations which can be configured for a brand. These spaces can provide experiences of brands which are based on the preference of the avatar which is in proximity of it, which again is based on translation of real world preference to the metaverse. As different avatars have different features, the real world preferences of the user or individual are merged with the features of the specific avatar to provide for an enhanced preference based advertisement for the customer or individual. As a security measure, the preference of the user or individual can be obscured in such a way that it does not leave behind any transaction footprint, such that the preferences and consents of the user are not known to others in the digital world or virtual world or the metaverse.

The exemplary embodiments of the present invention thus introduce individual-based marketing approaches in the metaverse where companies or brands can specifically target individual users or avatars in the metaverse based on the preferences and/or consents of the users.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

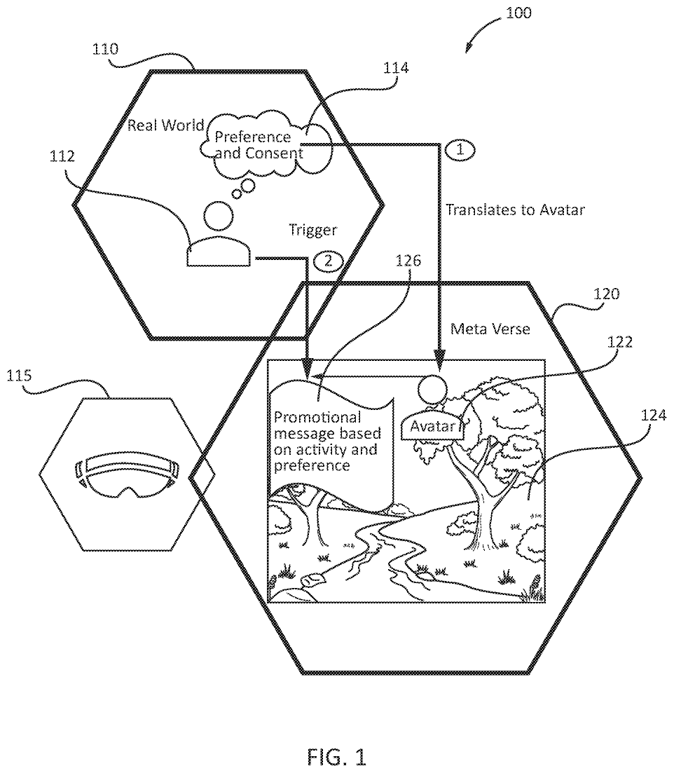

FIG. 1 is a block/flow diagram of individuals in the real world participating in the metaverse as avatars where an activity is triggered by the individual, in accordance with an embodiment of the present invention.

In a scenario 100, in the real world 110, an individual 112 designates his/her preferences and consent 114. The individual 112 wears a virtual reality headset 115 to access the metaverse 120. In the metaverse 120, the individual 112 is represented as an avatar 122 in a virtual environment 124. In the scenario 100, an activity is triggered by the individual 112. The activity triggered by the individual 112 results in a promotional message 126 displayed in the metaverse 120, which is visible to the avatar 122. In other words, as the individual 112 is participating in an event in the metaverse as the avatar 122, the individual 112 is permitted to trigger an activity within the metaverse 120. The activity can be, for example, the notification that the individual 112 is hungry. In the preferences and consent designation 114, the individual 112 has indicated that he/she prefers to eat a certain type of food when participating in various metaverse events. For example, the individual 112 prefers to eat pizza during such metaverse events. Additionally, the individual 112 has given consent to promotional brands that sell food that are participating in such events in the metaverse 120. As a result, a company in the metaverse 120, that is participating in such metaverse event, displays the promotional message 126, which relates to pizza purchase options. Thus, the promotional message 126 is based on an activity of the individual 112, and the preferences and consent of the individual 112. The metaverse 120 can also be referred to as a virtual world or a digital world.

Therefore, in accordance with FIG. 1, a company or brand does not blindly or randomly disseminate a marketing message to an entire crowd within an event occurring within the metaverse. Instead, the company or brand selectively targets individuals within an event occurring in the metaverse. This is not a crowd based marketing approach. In contrast, this is an individual-based marketing approach, which targets individual users. The companies or brands know which individuals or users to target, and what specific targeted messages to send to such individuals or users, based on the preferences of the individuals and based on the consent of the individuals that was predesignated or preestablished or chosen or selected beforehand.

Before an individual participates in the metaverse, the individual can choose or select what types of promotional messages to receive within the metaverse, from which companies or brands, for which events, and for which time periods during an event. For example, an individual can choose to receive promotional messages related to food and sneakers. The individual can further designate which companies are permitted to send promotional messages related to food and sneakers. Thus, the individual has full control of what types of messages to receive and who can send such messages to such individual. The individual further has full control in which events within the metaverse such messages can be transmitted in (e.g., only musical events, not sporting events). In such instance, the individual in the metaverse may not want to be bothered with promotional messages during a sporting event. The individual can also control the timing of such promotional messages. For instance, during a musical event, the individual may only want to receive promotional messages from companies or brands or sponsors only before the musical event starts or during an intermission period. The individual can designate receiving a promotional message after the band has played four songs for example. Therefore, the individual has full control of the timing of such promotional messages within the metaverse. The individual also has full control of the length of the promotional messages. The individual can designate, for example, that promotional messages can only have a length of 15 seconds or 20 seconds or 30 seconds. By length, it is meant the advertisement can be shown or presented for 15 seconds or 30 seconds, etc. The individual can also have control of the placement of the promotional message within the metaverse. The individual can designate, for example, that the promotional messages can only be displayed on the bottom of stage of a concert or on virtual chairs of the concert, and not over the performers or adjacent the performers or on the clothing of the performers. One skilled in the art can contemplate various different scenarios for displaying or not displaying such promotional messages in the metaverse.

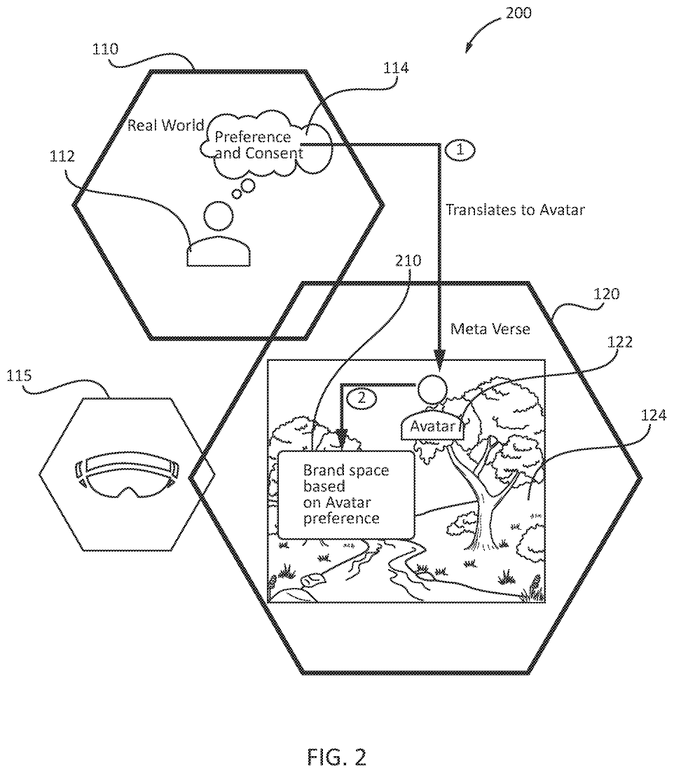

FIG. 2 is a block/flow diagram of individuals in the real world participating in the metaverse as avatars where a brand displays an advertisement based on an individual's preferences, in accordance with an embodiment of the present invention.

In a scenario 200, in the real world 110, an individual 112 designates his/her preferences and consent 114. The individual 112 wears a virtual reality headset 115 to access the metaverse 120. In the metaverse 120, the individual 112 is represented as an avatar 122 in a virtual environment 124. In the scenario 200, the individual 112 does not trigger an event. Instead, the company or brand itself, based on the preferences and consent designations 114 of the individual 112, displays promotional message 210 in an event and the metaverse where the individual 112 is participating as the avatar 122. Therefore, the brand itself may be permitted to display promotional message 210 on its own initiative. In FIG. 1 above, the individual 112 initiated or triggered the display of a message, whereas in FIG. 2, the company initiates or triggers the display of a message. The promotional message 210 aligns with the preferences and consent designations 114 of the individual 112. In other words, the promotional message 210 still needs to adhere to the preferences of the individual 112. For example, the individual 112 may have designated that the promotional message 210 can only be displayed for 15 seconds and can only be displayed in particular or specific areas or spaces or regions within the event in the metaverse 120. Even though the company or brand can initiate the promotional message 210, the promotional message 210 still needs to meet the strict requirements or conditions or prerequisites or stipulations selected or chosen by the individual 112.

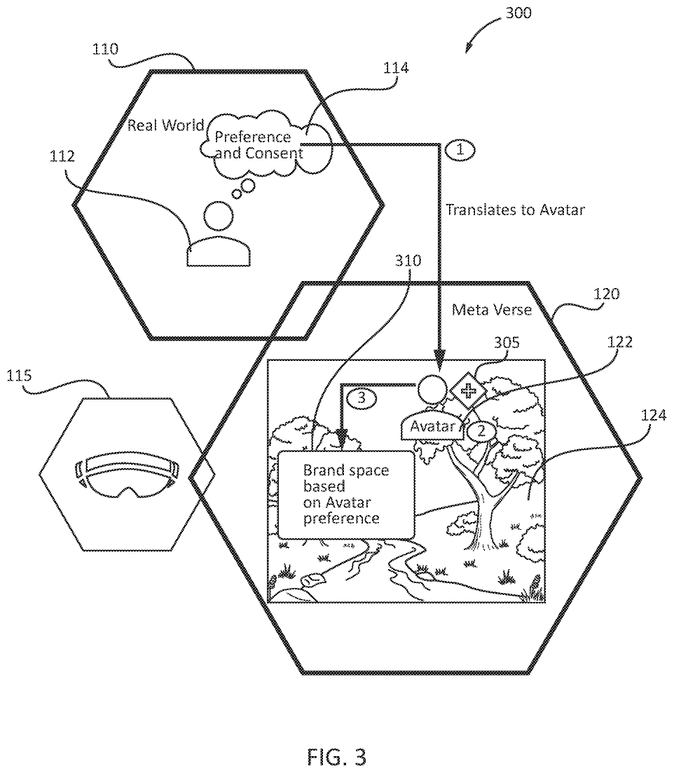

FIG. 3 is a block/flow diagram of individuals in the real world participating in the metaverse as avatars where a brand displays an advertisement based on a union of the avatar features and the real world preferences of the individual, in accordance with an embodiment of the present invention.

In a scenario 300, in the real world 110, an individual 112 designates his/her preferences and consent 114. The individual 112 wears a virtual reality headset 115 to access the metaverse 120. In the metaverse 120, the individual 112 is represented as an avatar 122 in a virtual environment 124. In the scenario 300, the promotional message 310 represents a union 305 of both preferences in the real world and features of the avatar 122. For example, the individual 112 can have multiple avatars in the metaverse. One avatar can participate in one event and another avatar can participate in another event concurrently or simultaneously. In a music event, the individual 112 has a first avatar. In a sporting event, the individual 112 has a second avatar. In a book signing event, individual 112 has a third avatar. In this scenario, the individual 112 has three different avatars in three different metaverse environments concurrently or simultaneously. In such a case, the brand shown for an avatar of the individual 112 can be a union 305 of preferences in both of the real world and the features of the avatars. The union 305 is a combination of the preferences in both of the real world and the features of the avatars.

Therefore, when the individual 112 concurrently or simultaneously participates in multiple events in the metaverse, then the company or brand can selectively target one or more of the avatars, or all the avatars at the same time. For the music event, the individual 112 can have a food preference, for the sporting event, the individual 112 can have a sneaker preference, and for the book signing event, the individual 112 can have a movie genre preference. Multiple companies or brands can thus concurrently or simultaneously target multiple avatars of the same individual 112 at multiple events within the metaverse. Similarly, a single company or a single brand can concurrently or simultaneously target multiple avatars of the same individual 112 at multiple events within the metaverse. The preferences of the individual can be combined or intermixed to provide for one or more promotional messages 310 (which take into account the combined preferences of the individual). The promotional messages 310 can be displayed to all of the avatars of the individual 112 concurrently or periodically or in different time intervals. The promotional messages 310 can be displayed to all the avatars in a time-staggered manner.

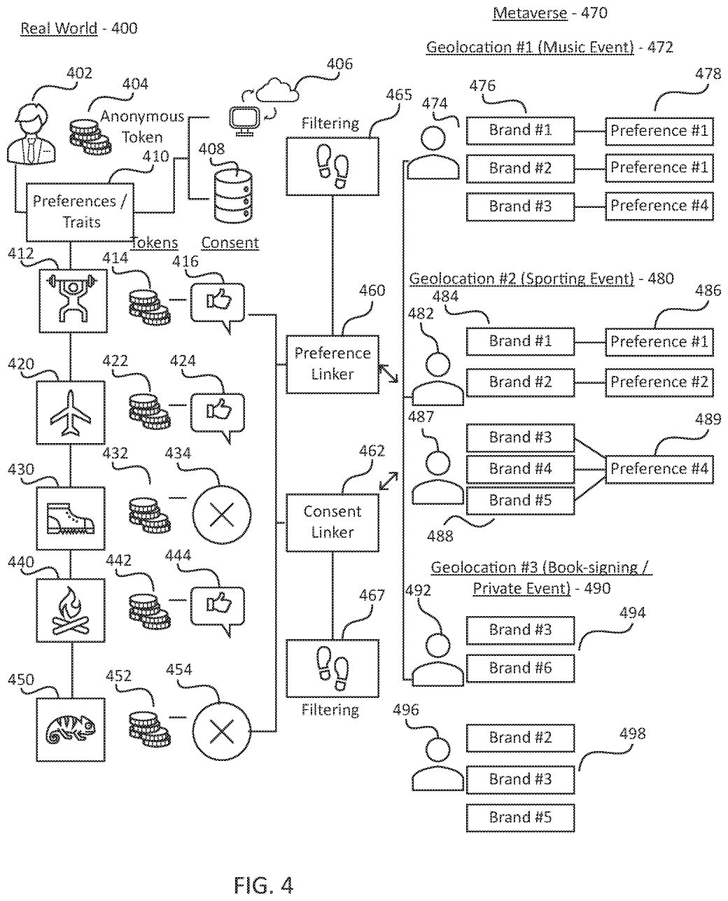

FIG. 4 is a block/flow diagram of a method for linking individuals in the real world with brands in the metaverse, in accordance with an embodiment of the present invention.

An individual 402 is located in the real world 400. An anonymous virtual token 404 can be linked to the individual 402. The individual 402 has a plurality of preferences 410. For example, a first preference 412, a second preference 420, a third preference 430, a fourth preference 440, and a fifth preference 450. The first preference 412 can be represented as a virtual token 414. The second preference 420 can be represented as a virtual token 422. The third preference 430 can be represented as a virtual token 432. The fourth preference 440 can be represented as a virtual token 442. The fifth preference 450 can be represented as a virtual token 452. The individual 402 is presented with the option to provide consent or no consent for each of the preferences. In the instant example, the individual 402 has given consent 416 to the first preference 412. The individual 402 has given consent 424 to the second preference 420. The individual 402 has given no consent 434 to the third preference 430. The individual 402 has given consent 444 to the fourth preference 440. The individual 402 has given no consent 454 to the fifth preference 450. Therefore, the individual 402 has full control of which preferences to give consent to. As a result, companies or brands or sponsors can only advertise or send targeted messaging or targeted advertising related only to the first preference 412, the second preference 420, and the fourth preference 440. The individual 402 is in full control of what targeted advertising to receive. The preferences 410 can be saved in a database 408 and can be shared on a cloud 406.

The individual 402 can create one or more avatars in the metaverse 470. For example, the individual 402 has created a first avatar 474 participating in a first geolocation 472. The individual 402 has created a second avatar 482 and a third avatar 487 both participating in a second geolocation 480. The individual 402 has created a fourth avatar 492 and the fifth avatar 496 both participating in a third geolocation 490.

In the first geolocation 472, a first brand can display promotional messages in the metaverse 470 regarding the first preference associated with the first avatar 474. A second brand can also display promotional messages in the metaverse 470 regarding the first preference associated with the first avatar 474. A third brand can also display promotional messages in the metaverse 470 regarding the fourth preference associated with the first avatar 474. Therefore, a plurality of brands 476 can display multiple promotional messages or advertising to the first avatar 474 pertaining to the plurality of preferences 478.

In the second geolocation 480, a first brand can display promotional messages in the metaverse 470 regarding the first preference associated with the second avatar 482. A second brand can also display promotional messages in the metaverse 470 regarding the second preference associated with the second avatar 482. A third brand, a fourth brand, and a fifth brand can all display promotional messages in the metaverse 470 regarding the fourth preference associated with the third avatar 487. Therefore, a plurality of brands 484 can display multiple promotional messages or advertising to the second avatar 482 and the third avatar 487 pertaining to the plurality of first preferences 476 and the plurality of second preferences 489. Thus, the individual 402 can have multiple avatars within the second geolocation 480. Each avatar within the second geolocation 480 can have different preferences assigned thereto, and also have different consents assigned to each of the different preferences. As a result, different brands or companies or sponsors can target different avatars of the same individual 402. The individual 402 can selectively assign which avatars, even in a same geolocation, can receive what types of promotional messages. The avatars of the individual 402 in a same geolocation can receive very different promotional messages from very different brands or sponsors or companies.

In the third geolocation 490, a third brand and a sixth brand (plurality of brands 494) can display promotional messages in the metaverse 470 to the fourth avatar 492. A second brand, a third brand, and a fifth brand (plurality of brands 498) can display promotional messages in the metaverse 470 to the fifth avatar 496. In this instance, the individual 402 has not designated any specific preferences for the third geolocation 490. However, the individual 402 had previously assigned preferences to the third geolocation 490. As such, the plurality of brands 494 associated with the fourth avatar 492 and the plurality of brands 498 associated with the fifth avatar 496 are in waiting or in pause or on the sidelines waiting to see if the individual 402 reactivates or retriggers any preferences while such individual 402 is participating in the private event of the third geolocation 490. Therefore, the individual 402 can activate or trigger preferences while an event is ongoing within the metaverse 470. The preferences of the individual 402 need not always be predetermined or pre-established or pre-selected. The preferences of the individual 402 can be activated or triggered at any time, even as the event is taking place in the metaverse 470. Thus, the individual 402 can have multiple avatars within the second geolocation 490. Each avatar within the second geolocation 490 can have different preferences assigned thereto (or no preferences), and also have different consents assigned to each of the different preferences.

The real world 400 is connected to the metaverse 470 by a preference linker 460 and a consent linker 462. The preference linker 460 is a component for sharing the preferences from the real world 400 with various geolocations in the metaverse 470. The consent linker 462 is a component for sharing the consents from the real world 400 with various geolocations in the metaverse 470. The preference linker 460 can include a filtering component 465 and the consent linker 462 can include a filtering component 467. The filtering component 465 can scrub or filter out the preferences selected or chosen by the individual 402 in any of the events or geolocations within the metaverse 470. In other words, the filtering component 465 and the filtering component 467 can remove or delete what the preferences (and/or consents) of the individual 402 were stated as. As a result, no transaction footprints are left behind on the platform or in the metaverse 470 regarding what events or geolocations the avatars of the individual 402 participated in (or what preferences were selected or what consents were given). All this information is kept secret or is kept hidden from the companies or brands or sponsors participating in the metaverse 470, or from anyone else. User privacy is thus maintained.

Therefore, according to FIGS. 1-4, a method and system is presented to create event based personas that exhibit events befitting traits or preferences from the individual's overall persona. Methods and systems are presented for linking a user's appropriate preferences and consents with the persona traits. Methods and systems are presented to supplement trait-linked preferences and consents with most frequently applied preferences. Methods and systems are presented to create anonymous virtual tokens linked to the identified persona with relevant validity. Methods and systems are presented to target brands based on a customer's preferences and geolocations of the respective avatars. Methods and systems are presented to associate relevant brands and products to prospective avatars based on the user preferences and consents. Methods and systems are also presented to use appropriate filtering or scrubbing mechanisms to avoid transaction footprints being left behind on the platform hosting different events that the avatars participate in. As a result, user privacy is protected in the metaverse as only virtual tokens are only displayed or presented. Transaction footprints can relate to any type of communication between the users and the brands, related to advertisements or not relate to advertisements.

Moreover, in one example embodiment, according to FIGS. 1-4, user i registers Avatar {Ai1, Ai2, . . . , Ain} at duration (t₁, t₂) on blockchain and gets virtual tokens {Vi1, Vi2, . . . , Vin}. Virtual tokens are public identity of the Avatar. Organizers of an event have a set of registered brands B={B_1, B_2, . . . , B_m} and bids b={b_1, b_2, . . . , b_m}.

User i has provided consent to receive promotional messages from certain brands. User i can appropriately map it to different avatars by submitting a blockchain transaction. The bid submitted by the advertiser j is b_j=([s_j, e_j], v_j) where v_j is bid value for . . . (s_j, e_j) per interested individual. (t₁, t₂) is the event start and end time.

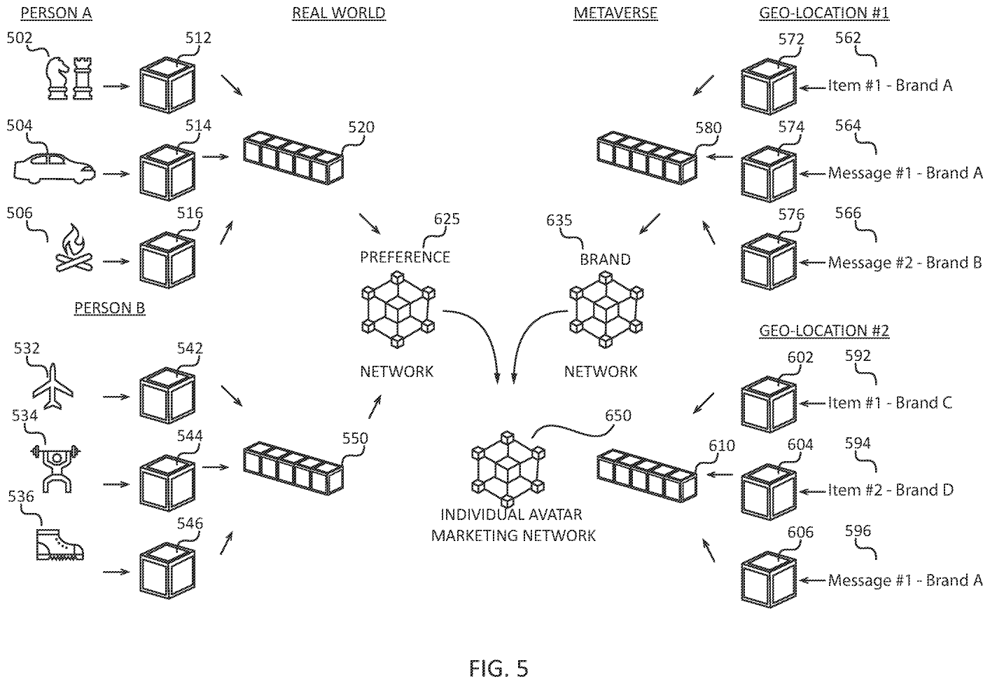

FIG. 5 is a block/flow diagram for implementing a blockchain for linking individuals in the real world with brands in the metaverse, in accordance with an embodiment of the present invention.

The exemplary embodiments of the present invention can be implemented in a blockchain configuration. A blockchain is a distributed database or ledger shared among a computer network's nodes. Blockchains are best known for their role in cryptocurrency systems for maintaining a secure and decentralized record of transactions, but they are not limited to cryptocurrency uses. Blockchains can be used to make data in any industry immutable, that is, an inability to be altered or modified.

Stated differently, a blockchain is a shared, immutable ledger that facilitates the process of recording transactions and tracking assets in a business network. An asset can be tangible (a house, car, cash, land) or intangible (intellectual property, patents, copyrights, branding). Virtually anything of value can be tracked and traded on a blockchain network, reducing risk and cutting costs for all involved. Blockchains are important because business runs on information. The faster it's received and the more accurate it is, the better. A blockchain is ideal for delivering that information because a blockchain provides immediate, shared and completely transparent information stored on an immutable ledger that can be accessed only by permissioned network members. A blockchain network can track orders, payments, accounts, production and much more. Since members share a single view of the truth, a person can see all details of a transaction end to end, giving the person greater confidence, as well as new efficiencies and opportunities.

In a blockchain, as each transaction occurs, it is recorded as a “block” of data. Those transactions show the movement of an asset that can be tangible (a product) or intangible (intellectual). The data block can record the information: who, what, when, where, how much and even the condition, such as advertisement communications between users and brands. Each block is connected to the ones before and after it. These blocks form a chain of data as an asset moves from place to place or ownership changes hands. The blocks confirm the exact time and sequence of transactions, and the blocks link securely together to prevent any block from being altered or a block being inserted between two existing blocks. Transactions are blocked together in an irreversible chain, that is, a blockchain. Each additional block strengthens the verification of the previous block and hence the entire blockchain. This renders the blockchain tamper-evident, delivering the key strength of immutability. This removes the possibility of tampering by a malicious actor and builds a ledger of transactions you and other network members can trust.

Referring back to FIG. 5, the individual targeted advertising system in the metaverse can be implemented by blockchain configuration. For example, a person A can exhibit or select or choose a first preference 502, a second preference 504, and a third preference 506. The first preference 502 can be represented as a block 512, the second preference 504 can be represented as a block 514, and the third preference 506 can be represented as a block 516. The blocks 502, 504, 506 can be represented as a data block 520 in the real world. Similarly, a person B can exhibit or select or choose a first preference 532, a second preference 534, and a third preference 536. The first preference 532 can be represented as a block 542, the second preference 534 can be represented as a block 534, and the third preference 536 can be represented as a block 546. The blocks 542, 544, 546 can be represented as a data block 550 in the real world. The data block 520 and the data block 550 can be combined and represented as a preference network 625. The preference network 625 can work in cooperation with the preference linker 460 and the consent to linker 462 of FIG. 4.

In the metaverse, in a first geolocation, an item 562 of brand A can be represented as a block 572, a first message 564 of brand A can be represented as a block 574, and a second message 566 of brand B can be represented as a block 576. The blocks 572, 574, 576 can be represented as a data block 580. Similarly, in a second geolocation, an item 592 of brand C can be represented as a block 602, a second item 594 of brand D can be represented as a block 604, and a first message 596 of brand A can be represented as a block 606. The blocks 602, 604, 606 can be represented as a data block 610. The data block 580 and the data block 610 can be combined and represented as a brand network 635. The brand network 635 can work in cooperation with the preference linker 460 and the consent to linker 462 of FIG. 4.

The preference network 625 can be combined with the brand network 635 to create or generate an individual avatar marketing network 650. The individual avatar marketing network 650 can be configured to allow communication between the real world and the metaverse. The individual avatar marketing network 650 can be configured to allow the individual to fully control his/her preferences and consents within the metaverse, which, in turn, allows the individual to fully control what advertisements or messages or promotions are displayed to the individual (and at what time and at what length) and control which advertisers or sponsors are permitted to transmit or display messages to the individual and in what spaces of the metaverse.

In one example embodiment, the individual may prefer advertisements from a specific advertiser or sponsor only in a specific space within the metaverse. In other words, the individual may accept advertisements from a specific advertiser only in a first geolocation within the metaverse. The first geolocation may be a specific event. If the individual transitions and to other spaces of the metaverse, then the advertiser would not be able to transmit such advertisements to the individual in those other spaces or regions or locations. Therefore, the individual can control the spaces in which he/she can receive advertisements or messages or promotions.

In another example embodiment, the individual may prefer advertisements only from a specific advertiser or sponsor of a specific product, for example, sneakers. In other words, the individual may accept advertisements only from this specific advertiser of sneakers. Therefore, other advertisers or sponsors or promoters of sneakers cannot display messages or promotions or advertisements to the individual.

In another example embodiment, the individual may prefer advertisements of 30 seconds or less regardless of the company or brand or advertiser or sponsor. Therefore, the individual can control the length of the advertisements that are provided to him/her.

The blockchain of FIG. 5 can be a public blockchain, that is, one that anyone can join and participate in. In another example, the individual-based marketing blockchain of FIG. 5 can be a private blockchain, such as a decentralized peer-to-peer network. One or more organizations govern the individual-based marketing approaches, controlling who is allowed to participate, execute a consensus protocol and maintain the shared ledger. This can significantly boost trust and confidence between participants.

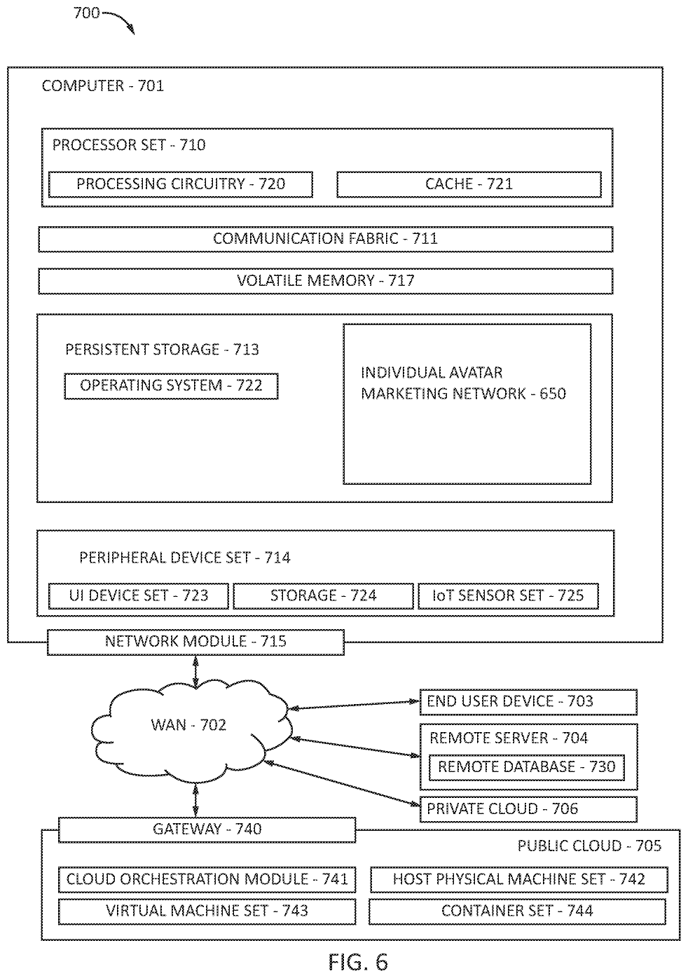

FIG. 6 is a block diagram of an exemplary computer system for applying the individual avatar marketing network, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the individual avatar marketing network 650. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 6. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

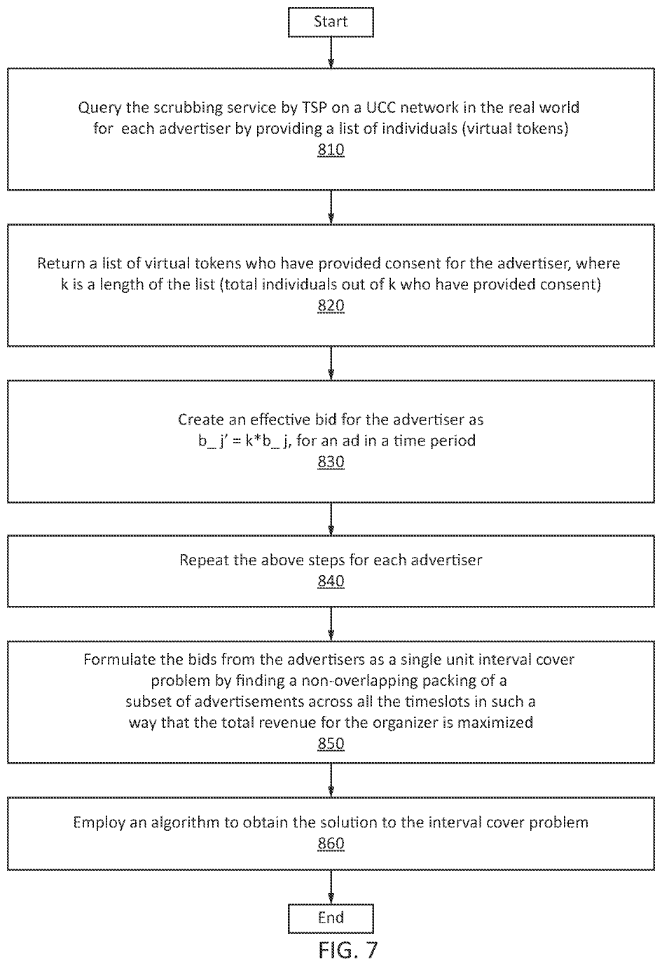

FIG. 7 is a block/flow diagram of an exemplary method for applying the individual avatar marketing network, in accordance with an embodiment of the present invention.

At block 810, query the scrubbing service by TSP on a UCC network in the real world for each advertiser by providing a list of individuals (virtual tokens).

At block 820, return a list of virtual tokens who have provided consent for the advertiser, where k is a length of the list (total individuals out of k who have provided consent).

At block 830, create an effective bid for the advertiser as b_j′=k*b_j, for an ad in a time period.

At block 840, repeat the above steps for each advertiser.

At block 850, formulate the bids from the advertisers as a single unit interval cover problem by finding a non-overlapping packing of a subset of advertisements across all the timeslots in such a way that the total revenue for the organizer is maximized.

At block 860, employ an algorithm to obtain the solution to the interval cover problem.

Stated differently, the exemplary method for applying the individual avatar marketing network includes enabling a plurality of users to interact with a virtual world through head-mounted display devices, each of the users represented as one or more avatars in the virtual world, obtaining preferences and consent of each of the users, displaying promotional messages to a user of the plurality of users in the virtual world based on the user's preferences and consent, and after displaying the promotional messages to the user, filtering the user's preferences and consent from the virtual world to remove transaction footprints.

In conclusion, a method and system is presented to create event based personas that exhibit events befitting traits or preferences from the individual's overall persona. Methods and systems are presented for linking a user's appropriate preferences and consents with the persona traits. Methods and systems are presented to supplement trait-linked preferences and consents with most frequently applied preferences. Methods and systems are presented to create anonymous virtual tokens linked to the identified persona with relevant validity. Methods and systems are presented to target brands based on a customer's preferences and geolocations of the respective avatars. Methods and systems are presented to associate relevant brands and products to prospective avatars based on the user preferences and consents. Methods and systems are also presented to use appropriate filtering or scrubbing mechanisms to avoid transaction footprints being left behind on the platform hosting different events that the avatars participated in. Transaction footprints are any type of communications between the users and the brands, whether related to advertisements/promotional messages or not.

Moreover, the example embodiments leverage a user's real time preferences and leverage relevant customer preferences to create event based advertisement in a virtual world, such as the metaverse. The preferences of the user can be obscured in such a way that no transaction footprints are left behind, and, thus, the preferences of the user are unknown to others and the metaverse and unknown to other advertisers or promoters or sponsors (maintaining privacy of user). At least one advantage of the exemplary embodiments of the present invention is that brands or advertisers or sponsors can perform targeted marketing of their products or services in the virtual world by leveraging a customer's real world preferences. As a result, relevant brand advertisement is positioned or presented or displayed to the customer based on the customer's preference(s) that were previously provided by the user. This will advantageously lead to a larger yield and higher success rate for the advertisers as they would be able to specifically target the right or appropriate avatars in the virtual world.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for individual-based marketing approaches in the metaverse (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
enabling a plurality of users to interact with a virtual world, each of the users represented as one or more avatars in the virtual world, using respective virtual reality headsets;
obtaining preferences and consent of each of the users, including combining preferences and consent for multiple avatars of a user concurrently participating in the virtual world;
displaying messages to the user in the virtual world based on the user's combined preferences and consent; and
after displaying the messages to the user, filtering the user's preferences and consent from the virtual world to remove transaction footprints.

2. The method of claim 1, wherein each of the users is represented as a virtual token in the virtual world.

3. The method of claim 1, wherein each of the preferences and consent of each of the users is represented as a virtual token in the virtual world.

4. The method of claim 1, wherein the user triggers an activity to initiate the displaying of the messages.

5. The method of claim 1, wherein an advertiser initiates the displaying of the messages based on the user's preferences and consent.

6. (canceled)

7. The method of claim 1, wherein the user's preferences include allowing the user to control placement of the messages within the virtual world.

8. The method of claim 1, wherein the user's preferences include allowing the user to control timing of the messages within the virtual world.

9. The method of claim 1, wherein the user's preferences include allowing the user to control a length of the promotional messages within the virtual world.

10. The method of claim 1, wherein the user's preferences and consent, and the messages are implemented in a blockchain configuration to generate an individual avatar marketing network.

11. A computer program product for implementing individual-based marketing approaches in a virtual world, the computer program product comprising a computer readable storage medium having program instructions embodied therewith, the program instructions executable by a computer to cause the computer to:
enable a plurality of users to interact with a virtual world, each of the users represented as one or more avatars in the virtual world, using respective virtual reality headsets;
obtain preferences and consent of each of the users, including combining preferences and consent for multiple avatars of a user concurrently participating in the virtual world;
display messages to the user in the virtual world based on the user's combined preferences and consent; and
after the messages are displayed to the user, filter the user's preferences and consent from the virtual world to remove transaction footprints.

12. The computer program product of claim 11, wherein each of the users is represented as a virtual token in the virtual world.

13. The computer program product of claim 11, wherein each of the preferences and consent of each of the users is represented as a virtual token in the virtual world.

14. The computer program product of claim 11, wherein the user triggers an activity to initiate the displaying of the messages.

15. The computer program product of claim 11, wherein an advertiser initiates the displaying of the messages based on the user's preferences and consent.

16. (canceled)

17. The computer program product of claim 11, wherein the user's preferences include allowing the user to control placement of the messages within the virtual world.

18. The computer program product of claim 11, wherein the user's preferences include allowing the user to control timing of the messages within the virtual world.

19. A system for implementing individual-based marketing approaches in a virtual world, the system comprising:
a memory; and
one or more processors in communication with the memory configured to:
enable a plurality of users to interact with a virtual world, each of the users represented as one or more avatars in the virtual world, using respective virtual reality headsets;
obtain preferences and consent of each of the users, including combining preferences and consent for multiple avatars of a user concurrently participating in the virtual world;
display messages to the user in the virtual world based on the user's combined preferences and consent; and
after the messages are displayed to the user, filter the user's preferences and consent from the virtual world to remove transaction footprints.

20. The system of claim 19, wherein each of the users is represented as a virtual token in the virtual world.
